(19) United States
(12) Patent Application Publication
(10) Pub. No.: US 2023/0143172 A1
(43) Pub. Date: May 11, 2023

(54) Subsea desalination system for shallow water

(71) Applicant: Waterise AS, Oslo (NO)

(72) Inventors: Davoud TAYEBI, Oslo (NO); Jo JERNSLETTEN, Haslum (NO); Tom Gunnar OMBERG, Oslo (NO); Morten HANA, Oslo (NO)

(21) Appl. No.: 17/910,699

(22) PCT Filed: Mar. 10, 2021
(86) PCT No.: PCT/NO2021/050062

§ 371 Date: Sep. 9, 2022

(30) Foreign Application Priority Data
Mar. 11, 2020 (NO) 20200296

(51) Int. Cl. C02F 1/44; B01D 61/08; B01D 61/04

(52) U.S. Cl. CPC C02F 1/441; B01D 61/08; B01D 61/04; C02F 2103/08

(57) ABSTRACT

The present invention relates to shallow water subsea desalination system with a subsea desalination template (20) located on a seabed. A retrievable subsea RO-module (4) is located in a subsea RO-module zone (23) of the subsea desalination template (20) and is connected to a RO-module connection. A seawater booster pump assembly (1) includes a seawater inlet (7) and an outlet in fluid connection with a seawater inlet side of the RO-cartridge assembly. A retrievable subsea booster module (2) includes the seawater booster pump assembly (1). A pressure regulator (11) is in fluid connection with a retentate side of the least one retrievable subsea RO-module (4).

The present invention relates to a subsea desalination system adapted to be located on the seabed at water depths less than a depth required to drive seawater through reverse osmosis (RO) membranes.

The subsea seawater shallow water desalination system may be designed as a modular subsea desalination system. The system includes a booster pump to boost the pressure from the hydrostatic pressure and to a pressure exceeding the osmotic pressure.

Reverse osmosis (RO) membranes can be located submerges at water depths providing a hydrostatic pressure greater than the osmotic pressure (Tr) allowing the hydrostatic pressure to drive the seawater through the reverse osmosis (RO) membranes. This water depth is typically greater than 300 m. It is however not that deep in many places requiring fresh water, and it is an object of the present invention to provide a desalination system in such areas. The term “shallow” in the context of the disclosure is intended to describe a water depth less than a depth that will provide sufficient hydrostatic pressure required for reverse osmosis.

Desalinated water is typically required in densely populated areas with high real-estate prices or limited access to land. Is an object of the present invention to provide a water desalination system where virtually no land area is required.

Reverse osmosis (RO) membranes can be placed in seawater at a water depth providing to a hydrostatic pressure less than the osmotic pressure (Tr) provided the pressure is boosted. A water depth is typically less than 285 m. A pressure greater than a hydrostatic pressure and a boosted pressure combined can be utilized in a desalination process to push water molecules through RO-membranes. A pump providing boosted pressure through the RO membranes is located upstream of the RO membranes, thus pumping the full flow rate of seawater.

A pressure regulating device maintains the pressure in the system at the desired level.

Energy used to press parts of the seawater through the RO-membranes can be regenerated to provide a less energy consuming system, and the energy can be regenerated directly through a mechanical connection between one of the pumps in the system and a regenerator or through an electric system including a regenerator with an electric generator.

The present invention is based on the above-mentioned principle. The desalination system of the invention is adapted to be located at a designated water depth on the seabed. A booster pump drives a flow of seawater through an array of RO-membranes. The retentate (high salinity concentrated seawater) from the RO-membranes is discharged locally through a pressure regulating device.

Permeate (desalinated water) may be pumped with a transport pump to desalinated water receiving facilities. The transport pump generates a pressure difference decreasing the inlet pressure of the transport pump, thus the permeate pressure of the RO membranes is equal to the inlet pressure of the transport pump. This provides the necessary differential pressure over the RO membranes to drive Reverse Osmosis. With this setup, seawater can be desalinated utilizing hydrostatic pressure present in the surrounding seawater, combined with the added pressure from the booster pump.

In an alternative embodiment the transport pump may be omitted it the bosting pump generates sufficient pressure to pump the seawater through the RO modules and the desalinated water further to a location above the sea level. This solution is however considered as less favourable.

The present invention thus concerns a subsea shallow water desalination system. The system includes a subsea desalination template adapted to be located on a seabed, including at least one RO-module zone, at least one RO-module connection and desalination template piping in fluid connection with the at least one RO-module connection. At least one retrievable subsea RO-module is adapted to be placed in the at least one RO-module zone of the subsea desalination template, the at least one retrievable subsea RO-module including a RO-template connection adapted to be connected to the at least one RO-module connection, and at least one RO-cartridge assembly in fluid connection with the RO-template connection. At least one seawater booster pump assembly includes a seawater inlet, and an outlet adapted to be in fluid connection with a seawater inlet side of the at least one RO-cartridge assembly. At least one retrievable subsea booster module includes the at least one seawater booster pump assembly. At least one booster module template connection is located on the at least one retrievable subsea booster module and is adapted to be connected to a booster module connection on a template with a booster module zone. At least one desalinated water line is adapted to convey desalinated water from the at least one retrievable subsea RO-module and to a location above a sea level. A pressure regulator is in fluid connection with a retentate side of the least one retrievable subsea RO-module to provide sufficient backpressure for the RO-module.

The template with a booster module zone may be the desalination template.

The shallow water subsea desalination system may further include at least one desalinated water transport pump assembly in fluid connection with a desalinated water side of the at least one RO-cartridge assembly in the retrievable subsea RO-module.

The at least one seawater booster pump assembly and the at least one desalinated water transport pump assembly may be located in the booster module.

The at least one desalinated water transport pump assembly may be located in a retrievable subsea desalinated water transport module, and the retrievable transport module may be adapted to be located in a desalinated water transport module zone.

The pressure regulator may include an energy recovery assembly.

The energy recovery assembly may be is located in a separate retrievable energy recovery module.

The energy recovery assembly may include a turbine aggregate with a turbine and one of an electric generator and a mechanical connection through a transmission to the booster pump or the transport pump.

The shallow water desalination system may further include at least one retrievable control module located in at least one control module zone on the desalination template.

The shallow water desalination system may further include a prefilter assembly in a retrievable prefilter module upstream of the booster pump assembly.

The retrievable prefilter module includes a filter and may be located on a separate filtering and pumping station, and the booster module (2) may be located on the filtering and pumping station upstream of and in fluid connection with the desalination template.

At least one separate transport module template with the at least one transport module may be located on a downstream side of the at least one subsea desalination template may include a desalinated water inlet and a desalinated water outlet, whereby the separate pump template with the at least one transport module is adapted to convey the desalinated water from the desalination template.

The at least one separate pump template with the at least one transport module may be located on a downstream side of the at least one subsea desalination template may and include a desalinated water inlet and a desalinated water outlet, whereby the separate pump template with the at least one transport module is adapted to convey the desalinated water from the desalination template.

The shallow water desalination system may further include a permanent seabed foundation secured to seabed anchoring elements, and wherein any of the subsea templates are adapted to be located on top of the permanent seabed foundation.

The subsea templates include a transport module template, a booster module template, a desalination template, a filtering template or any template with any combination of retrievable modules.

Any of the subsea templates may be adapted to be located on a further base template in fluid connection with the desalinated water pipeline and a concentrated seawater outlet.

The further subsea base template may be adapted to be located on top of a permanent seabed foundation.

Furthermore, the invention concerns a subsea desalination booster module for a desalination system as described above. The subsea desalination booster module, includes at least one seawater booster pump assembly with an inlet and an outlet adapted to be in fluid connection with a seawater inlet side of at least one RO-cartridge assembly. At least one booster module template connection on the at least one retrievable subsea booster module is adapted to be connected to a booster module connection on a template with a booster module zone.

A method exchanging a used subsea RO-module installed on a subsea desalination system as described above is also disclosed. The method includes identifying that the used subsea RO-module require service based on regular scheduled intervals or parameters selected from the group of parameters, desalinated water flow rate, water pressure drop over the subsea RO-module and desalinated water salinity. A vessel is then provided above the subsea desalination system. Subsea desalination module lifting means are lowered onto the used subsea RO-module. The subsea desalination module lifting means are secured to the used subsea desalination module. The used subsea RO-module is released from a subsea desalination template. The subsea desalination module lifting means and the used subsea desalination module are lifted on to the vessel. The subsea desalination module lifting means and an exchange subsea desalination module are lowered onto subsea the desalination template. The exchange subsea RO-module is secured to the subsea desalination template, and the subsea desalination module lifting means are released from the exchange subsea desalination module.

### SHORT DESCRIPTION OF DRAWINGS

FIG. 1 Is a schematic representation of the invention;

FIG. 2 Is a schematic side view of an embodiment of the invention;

FIG. 3 Is a schematic side view of another embodiment of the invention;

FIG. 4 Is a schematic side view the invention;

FIG. 5a Top view of an embodiment of the invention;

FIG. 5b Top view of another embodiment of the invention;

FIG. 6 is a schematic representation of a first step of an installation of a part of a subsea desalination system of the invention on a seabed;

FIG. 7 is a schematic representation of a second step of the installation initiated in FIG. 6;

FIG. 8 is a schematic representation of an installed subsea desalination system of the invention;

FIG. 9 is a schematic representation of a first step of an installation of a complete subsea desalination system of the invention;

FIG. 10 is a schematic representation of a subsea desalination system of the invention with twelve desalination system templates;

FIG. 11 shows a detail of FIG. 10 with three templates;

FIG. 12 is schematic representation of an alternative configuration of a desalination system of the invention with a separate pump template;

FIG. 13 is schematic representation of a desalination system in an alternative embodiment with a floating desalinated water receiving facility;

FIG. 14 shows the embodiment of FIG. 13 during a module exchange step;

FIG. 15 shows the embodiment of FIG. 13 further including a floating power generation unit;

FIG. 16 shows an alternative embodiment of the invention with a seawater inlet at a remote location relative to a template;

FIG. 17 shows an alternative embodiment of the invention with a seawater inlet at a remote location above a template;

FIG. 18 shows an alternative embodiment of the invention with a desalinated water transport pump template separate from a water desalination template;

FIG. 19 show details of desalination RO-modules for the desalination system of the invention;

FIG. 20 show details of alternative desalination RO-modules for the desalination system of the invention;

FIG. 21 is a schematic representation of a subsea desalination system with template on permanent seabed foundation and jumpers between modules;

FIG. 22 is a schematic representation of a subsea desalination system with a desalination template and a pump template on a base template located on a permanent seabed foundation; and

FIG. 23 is a schematic representation of a subsea desalination system with a desalination template located on a permanent seabed foundation.

### DETAILED DESCRIPTION OF EMBODIMENTS OF THE INVENTION WITH REFERENCE TO THE FIGS

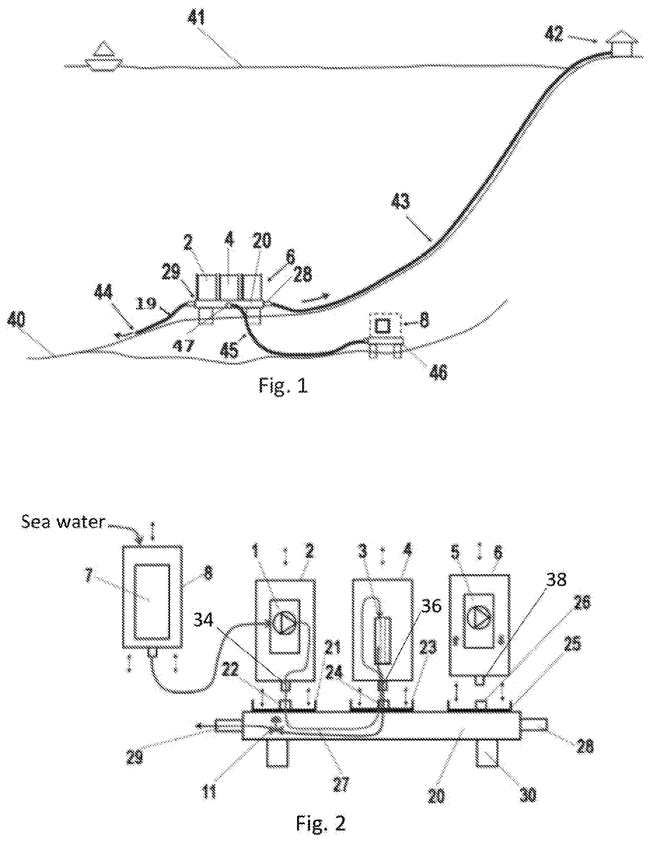

FIG. 1 shows an embodiment of the invention with a desalination template 20 on a seabed 40. Retrievable desalination RO-modules 4 are located in dedicated desalination module zones on the desalination template 20. A line 19 for concentrated seawater is in fluid contact with a seawater side of the desalination RO-modules and includes an outlet 44 for concentrated seawater. The outlet 44 for concentrated seawater is located at a distance from an inlet for seawater to prevent the concentrated seawater from entering the seawater inlet. A seawater inlet line 45 is connected to a seawater inlet 47 on the subsea desalination template 20.

A shore based desalinated water receiving facility 42 connected to the desalination template 20 through the desalinated water pipeline 43, requires a small footprint comparted to a complete desalination plant.

The inlet line 45 connected to a separate seawater prefilter station with a prefilter on a separate pump template 46 with one or more seawater prefilter modules 8 form a prefilter template station with a seawater entrance. The one or several prefilter modules 8 include one or several inlet/pre-filters assemblies. A downstream booster module 2 in the subsea template 20, feed seawater through the RO-module 4. The prefilter station is an inlet unit with a seawater entrance on the prefilter of the separate pump template 46 forming a separate structure away from the desalination template 20. Seawater flows through the filtering station for pre-filtration or pre-treatment before it enters the RO-modules 4. Each prefilter assembly may include one or more filters with different properties.

The booster pump assembly in the booster module 2 on the desalination template 20 increases the seawater pressure up to osmotic pressure. The booster pump assembly 2 also operates as a circulation pump for the desalination system and enables discharge of concentrated seawater through the concentrated seawater outlet 44 at an end of a concentrated seawater line 19 connected to the desalination template 20 in concentrated seawater coupling 29.

A transport pump assembly in a transport module 6 pumps the desalinated water through the coupling 28, through the desalinated water line 43 and to the desalinated water receiving facility located above the sea-level 41.

All modules are retrievable and replaceable.

FIG. 2 is a schematic representation of a modular subsea desalination system of the invention. The subsea modular desalination system is located on the template 20 which has subsea anchoring elements 30. A separate seawater prefilter assembly 7 is located in a prefilter module 8 and supplies filtered seawater to the booster pump assembly in the booster module 2. The prefilter module 8 may be located on the template 20 or at another location as shown in FIG. 1.

The booster pump assembly 1 in FIG. 2 typically includes a seawater pump, an electric motor driving the seawater pump and various control systems and sensors. A seawater inlet for a filtered seawater line from the prefilter module 8 is in liquid connection with the booster module 2. The booster module 2 is located in a booster module zone 21 and delivers pressurized seawater to desalination template ducting or piping 27 in/on the desalination template 20 through a booster pump template connection 34 (on the booster module 2) and through a booster module connection 22 (on the desalination template 20). The pressure delivered by the booster pump assembly depends on the depth the system is designed for. Similarly, the back pressure provided by the pressure regulator 11 is adapted to the design depth and the booster pump. The pressure regulator 11 may be variable or may provide a fixed back pressure.

The connections 22, 24, 26 in the module zones 21, 23 and 25 are typically fluid couplings but may also include electrical couplings for power and control between the modules and from a control and power unit above sea-level, typically in connection with the desalinated water receiving facility 42 (FIG. 1)

The RO-module 4 includes one or several RO-cartridges in a RO-cartridge assembly 3. The RO-module 4 is located in an RO-module zone 23 and receives pressurized, filtered seawater from the booster module 2 and the desalination template ducting or piping 27 through an RO-module template connection 36 (on the RO-module 4) and through an RO-module connection 24 on the desalination template 20. The RO-module connection 24 also allows desalinated water to flow from the RO-module 4, and into the desalination template ducting or piping 27. The RO-module connection 24 also allows concentrated seawater to flow from the RO-module 4, into the desalination template ducting or piping 27, and into a pressure regulator 11.

The transport module 6 includes a pump assembly 5. The pump assembly 5 typically includes a desalinated water pump, an electric motor driving the desalinated water pump and various control systems and sensors. The transport module 6 is located in a transport module zone 25 and delivers pressurized desalinated water to the desalinated water line coupling 28 through a transport pump template connection 38 (on the transport module 6) and through a transport module connection 26 on the desalination template 20. The transport module connection 26 also allows desalinated water to flow from the desalination template ducting or piping 27 and into the transport module 6.

The pressure regulator 11 maintains osmotic pressure in the RO-cartridge assembly 3 and is connected to the desalination template ducting or piping 27 and to the concentrated seawater coupling 29.

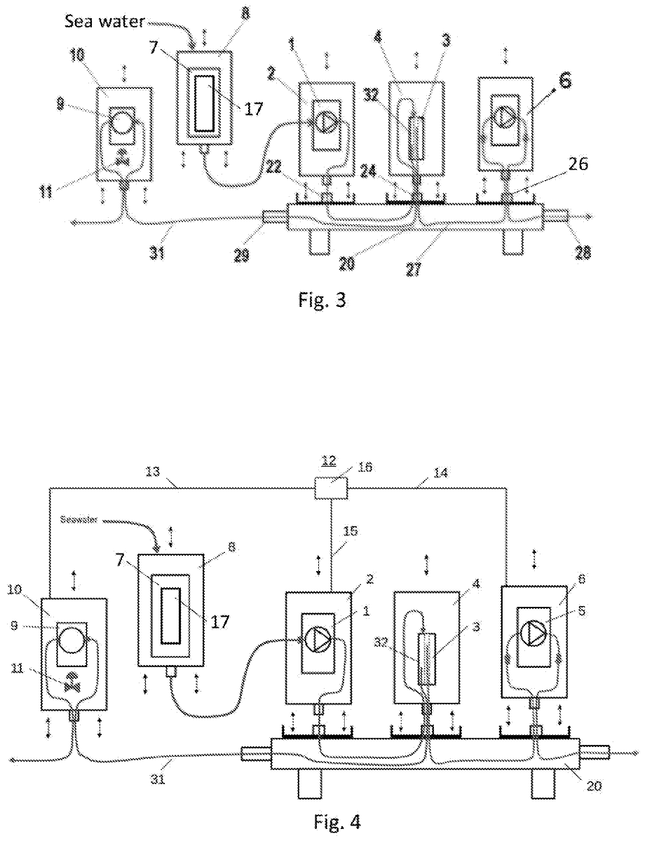

FIG. 3 is a schematic representation of a modular subsea desalination system of the invention corresponding to the system of FIG. 2. Additionally, FIG. 3 includes an energy recovery assembly 9 acting as the pressure regulator 11 in an energy recovery module 10. The energy recovery module 10 receives a pressurised flow of concentrated seawater from the concentrated seawater coupling 29. A boosted pressure flow path 31 extends between the booster pump assembly 1, through the booster module 2, through the booster module connection 22, through the subsea template piping 27, through the RO-module connection 24, through the RO-module 4, through a seawater side 32 of the RO-cartridge assembly, through the RO-module 4, back through the RO-module connection 24 and into the subsea template piping 27, out through the concentrated seawater coupling 29, and through a suitable duct/piping into the energy recovery module 10 with the energy recovery assembly 9 before the concentrated seawater is discharged to the surrounding seawater.

The energy recovery assembly 9 is typically a turbine aggregate with a turbine and an electric generator. The turbine aggregate may alternatively be mechanically (or hydraulically) connected through a transmission to the booster pump or the transport pump.

The turbine must provide a sufficient back pressure to provide the osmotic pressure over the RO-membranes in the RO-cartridge assemblies 3.

The energy recovery assembly 9 may also include a pressure regulator 11 to ensure that the backpressure always is sufficient to provide the osmotic pressure over the RO-membranes.

The desalinated water from the RO-cartridge assemblies 3 in the RO-modules 4 flows through the RO-module connection 24 through the ducting 27 to the transport module 6. The desalinated water is pumped through the water line coupling 28, through the water line to the receiving facility. A booster module template connection 34 connects the module with the booster pump with the template and may include connections for both power, control, a water inlet and a water outlet and is connected to the booster module connection 22.

Similarly connects the RO-module template connection 36 the RO-module with the template and may include connections for both power, control, a water inlet and a water outlet and is connected to the RO-module connection 24.

Finally does the transport module template connection 38 connect the transport module with the template and may include connections for both power, control, a water inlet and a water outlet and is connected to the transport module connection 26.

The seawater enters the seawater prefilter module 8 and flows into the seawater prefilter assembly 7. The seawater is filtered with the seawater inlet filter 17 in order to obtain the target feed seawater quality into the system.

FIG. 4 is a schematic representation of a modular subsea desalination system of the invention corresponding to the system of FIG. 3. Additionally, FIG. 4 includes an energy transfer connection 12. The energy transfer connection 12 may include a recovery powerline 13 extending between the energy recovery assembly 9 and a power distribution connector 16, further connecting the power to the booster pump assembly 1 through a booster pump power line 15 and/or to the transport pump assembly 5 through the transport pump power line 14. The power distribution connector 16 may be omitted if the power is led directly to the booster pump assembly 1 or the transport pump assembly 5. The energy transfer connection 12 is typically an electrical connection but may also represent a mechanical transmission.

The seawater prefilter module 8 and the energy recovery module 10 are shown as individual units, but these will typically be located on the desalination template 20 or on separate, dedicated templates (not shown) similar to the desalination template.

The embodiment of FIG. 4 corresponds to the previously shown embodiments: In the embodiment of FIG. 4, the booster pump assembly 1 in the booster module 2 can provide a pressure that is above the osmotic pressure and the pressure that is required to pump the desalinated water up above sea-level and to the desalinated water receiving facility combined. In this embodiment the transport module 6 can be omitted. Power is regenerated in the energy recovery assembly 9 and is fed to the booster pump assembly 1 through the power lines 13 and 15. The power can be electrical or mechanical as before.

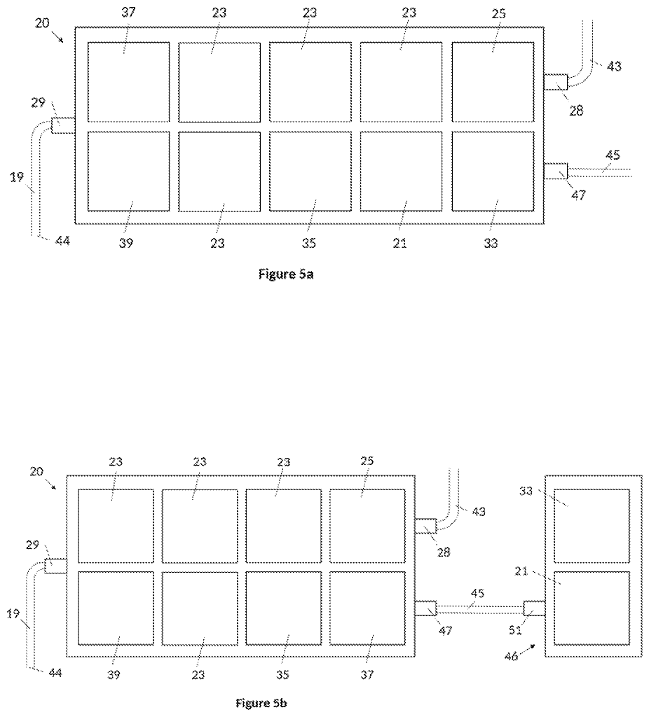

FIG. 5a is a schematic top view of a desalination template with module zones for the various modules. The module zones are represented with open squares. The template 20 includes RO-module zones 23. The remaining zones including a booster module zone 21, a transport module zone 25, a seawater prefilter module zone 33, an energy recovery module zone 35, and a cleaning module zone 37. The connections in the module zones 21, 23, 25, 33 and 35 are typically fluid couplings but may also include electrical couplings for power and control between the modules and from a control and power unit above sea-level, typically in connection with the desalinated water receiving facility 42 (FIG. 1).

FIG. 5a includes a seawater inlet 47 to the template 20 connected to a seawater inlet line 45. The seawater inlet 47 and inlet line 45 may be omitted if the prefilter module mounted into the prefilter module zone 33 includes the seawater inlet to the system.

FIG. 5a includes the concentrated seawater coupling 29 and the concentrated seawater line 19 where the concentrated seawater is discharged out of the system to the surrounding seawater at the concentrated seawater outlet 44.

FIG. 5a includes the desalinated water coupling 28 and the desalinated water line 43. The desalinated water line 43 connects the subsea template 20 to the receiving facility 42 as shown in FIG. 1.

The desalination template in FIG. 5a also includes a control module zone 39.

FIG. 5b is another schematic top view with a desalination template 20 and a prefilter on the separate pump template 46. The booster module is here mounted into the booster module zone 21 on the prefilter template. In this case the desalination system template 20 does not have a booster module. At least one seawater prefilter module zone 33 is located on the separate pump template 46.

The desalination template 20 in FIG. 5b is connected to the separate pump template 46 with the seawater inlet line 45. The seawater inlet line 45 provides the liquid conduit between the seawater outlet 51 from the separate pump template 46 and the seawater inlet 47 on the desalination template 20.

FIG. 5b includes the concentrated seawater coupling 29 and the concentrated seawater line 19 where the concentrated seawater is discharged out of the system to the surrounding seawater at the concentrated seawater outlet 44.

FIG. 5b includes the desalinated water coupling 28 and the desalinated water line 43. The desalinated water line 43 connects the subsea template 20 to the receiving facility 42 as shown in FIG. 1.

The desalination template 20 in FIG. 5b includes RO-module zones 23, transport module zone 25, energy recovery module zone 35, cleaning module zone 37 and the control module zone 39.

The connections in the module zones 21, 23, 25, 33 and 35 are typically fluid couplings but may also include electrical couplings for power and control between the modules and from a control and power unit above sea-level, typically in connection with the desalinated water receiving facility 42 (FIG. 1).

The desalination system described above may also include at least one retrievable control module located in a control module zone on the desalination template or on a separate template.

The template or templates may be located directly on a seabed or on a dedicated foundations or bases on the seabed. The seawater intake is typically at a distance from the seabed to prevent matter from the seabed from entering the intake.

The connections of the modules may also include flying leads.

All the modules may be located in dedicated templates or in one or several common templates.

All or a selection of the connections to the modules may go through the template or templates.

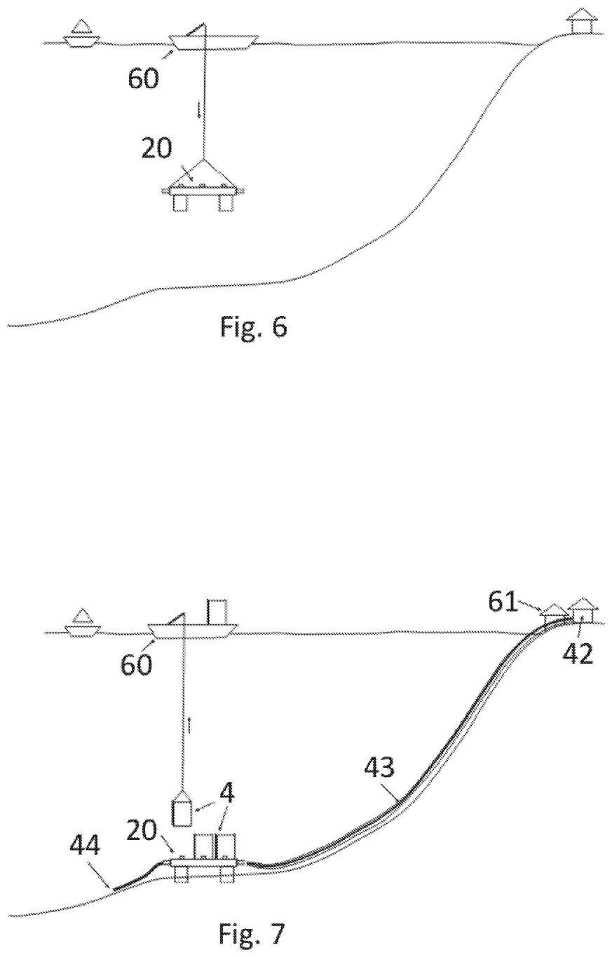

FIG. 6 shows a first installation step of a subsea desalination template 20. The subsea desalination template 20 is lowered from an installation/service vessel 60 towards a seabed.

The subsea desalination template 20 is prefabricated and is installed at a designated water depth. The template is installed as a one-time event landing it on its location using the installation/service vessel 60. The template is designed to support the total weight of a system including installation and operational tools and equipment. The template may contain internal piping or ducts, cables, valves and connections for water, power, data and chemicals. Alternatively, the template is landed on a permanent seabed foundation or base (not shown in FIG. 6) and the seabed foundation then represents the structure installed as the one-time event on its location using the installation vessel 60.

The subsea desalination template 20 or the seabed foundation is adapted to be located on the seabed and this may involve designing the subsea desalination template/foundation as a permanent base structure located at the seabed with installation slots or zones for modules and serves as a landing and operating base for modules (including desalination modules, pump modules, inlet modules, chemical modules, instrumentation and control modules). Alternatively, the template may be adapted to be located on the seabed by adapting it to be located on a separate permanent base structure installed on the seabed ahead of the template. The subsea desalination template 20 (or the seabed foundation) is fixed to the seabed with suction anchors. Other fixing mechanisms (not shown) may include mud mats, wires, concrete dumps, loads or pillars. A subsea desalination template 20 is usually installed in place permanently or for a long period such as the operation time or life time of the desalination system. The subsea desalination template 20 in FIG. 6 is shown installed without the modules.

Alternatively, the subsea desalination template 20 may be located on top of the seabed foundation installed ahead of the subsea desalination template on the seabed.

The subsea desalination template 20 may be retrieved from the seabed by the service vessel 60. The structure and foundation depend on the actual seabed conditions and requirements.

When the various subsea elements are installed and fixed at the seabed, a transportation pipeline for desalinated water, power and data cables for pumps and subsea equipment and chemical/supply lines may be installed and connected to the template/s.

The subsea desalination template 20 may be installed at the seabed with a pipeline and cables (already) connected to it.

FIG. 7 shows the subsea desalination template 20 of FIG. 6 installed on a seabed. The subsea desalination template 20 includes suction anchors or other suitable elements forming a foundation for the template. Standardized modules including desalination RO-modules 4 are lowered from the service vessel 60 (installation vessel) and onto the subsea desalination template 20. The stepwise installation eases the requirements of the service vessel 60. The installation also includes installing a connection line including a power line and a desalinated water pipeline 43 from the subsea desalination template 20 to a land based desalinated water receiving facility 42. A line for cleaning chemicals may also run from the desalinated water receiving facility and to the subsea desalination template 20 along with the connection line including the power line and the desalinated water pipeline 43. The desalinated water receiving facility 42 can include a pumping station. The system may also include a supply base 61 for offshore operations and for transporting the desalinated water to another location.

The desalinated water receiving facility 42 also provides power and two-way data communication to the template.

The modules include at least one desalination RO-module 4 with a plurality of RO-filter cartridges and one pumping module with a booster pump for continuous feeding of seawater to the RO-filter cartridges and a transportation pump pumping desalinated water to the desalinated water receiving facility 42. The modules including the desalination RO-module 4 stab into the subsea desalination template 20 with stab-in connections e.g. well known from subsea hydrocarbon production facilities. The stab-in connections may connect the desalination RO-module 4 to the subsea desalination template 20 upon landing of the desalination RO-module 4 in a desalination RO-module zone on the subsea desalination template 20.

Alternatively, these connections may be substituted with connections connected using an ROV (Remotely Operated Vehicle). For the desalination RO-modules with RO-filter cartridges, the connections typically include a connection for seawater, a connection for desalinated water, a connection for concentrated seawater and connections for transferring signals relating to the status of the module. Connections for cleaning chemicals may also be included.

A concentrated seawater outlet 44 with an extended discharge pipeline is installed in conjunction with the subsea desalination templates 20 to lead the concentrated seawater away from the desalination system. The desalination RO-modules 4 and pump, control and chemical modules are installed on the subsea desalination template 20 at the seabed using e.g. the service vessel 60. The service vessel 60 has a crane with required lifting capacity to reach the subsea desalination template 20 on the seabed. It is advantageous if the service vessel has capacity to carry several modules in one campaign.

Power to the subsea desalination system is supplied either from shore via subsea power cable/s or by local marine power generation e.g. fuel, wind, solar or wave power. Power and instrumentation cables may be built into the connection line as one cable bundle or laid together. The subsea desalination template 20 may be located on a stand on the foundation to localize the template a certain distance above the seabed to prevent mud and debris from the seabed from being entrained in the water flow to the desalination RO-modules.

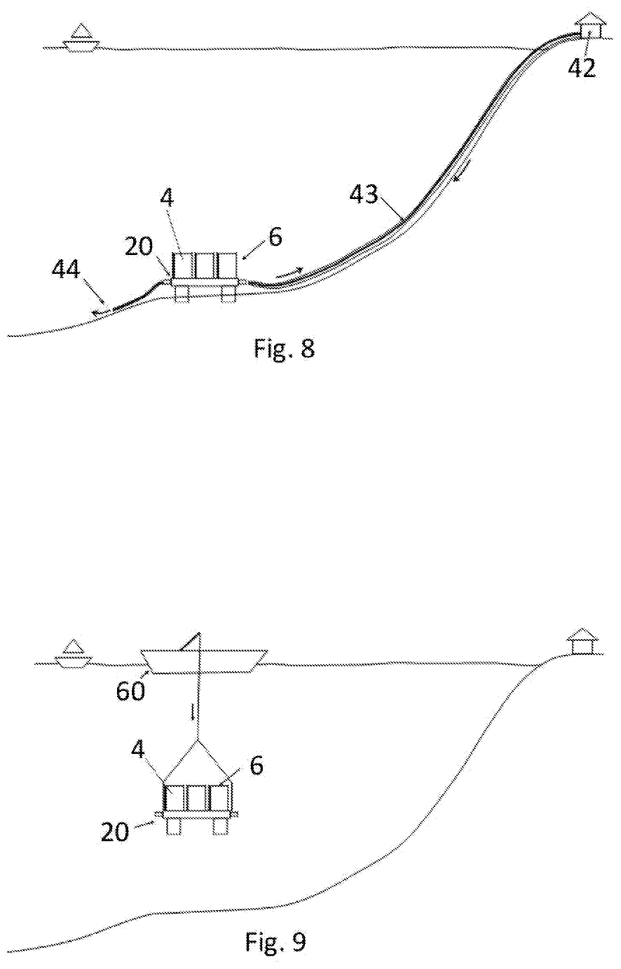

FIG. 8 shows a subsea desalination system with the subsea desalination template 20, and desalination RO-modules 4 and other modules installed on the seabed. A pump in a transport module 6 pumps desalinated water represented by an arrow pointing towards the right along the connection line including the desalinated water pipeline 43 in the form of water transportation lines to a desalinated water receiving facility 42. An arrow pointing towards the left along the connection lines represent electric power to the pumps in the transport modules 6. Concentrated seawater is expelled through the concentrated seawater tubular with the concentrated seawater outlet 44.

FIG. 9 shows an alternative installation method including installing a complete subsea desalination system with the subsea desalination template 20 and modules including the desalination RO-modules 4 from a service vessel 60 in a single operation. The installation method will for instance depend on the allowable load rating of the service vessel 60.

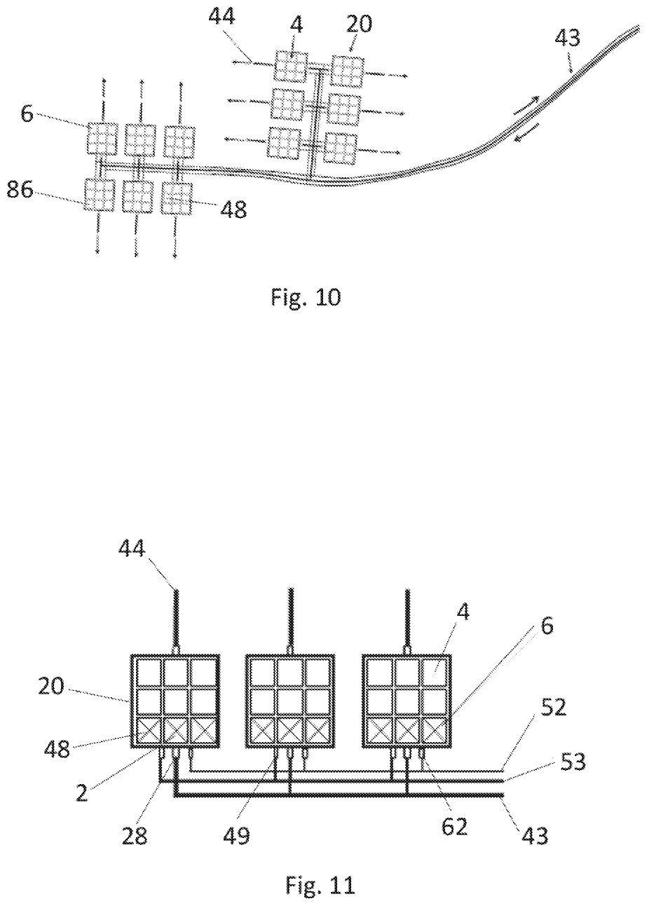

FIG. 10 shows a subsea desalination plant with twelve desalination templates 20 as seen from above. Each desalination template 20 includes nine modules whereof four desalination RO-modules 4, a transport module 6, a retrievable control module 86, a retrievable chemical injection module 48 a retrievable booster module and a retrievable energy recovery module. The desalination templates 20 are connected to desalinated water branch pipes feeding into a forming a common desalinated water line 43 conveying desalinated water to a desalinated water receiving facility. Each desalination RO-module 4 is also connected to power supply cables and control cables. Discharge tubulars with the concentrated seawater outlet 44 discharge concentrated seawater. Each square represents a module. FIG. 10 illustrates that the plant is easily scalable to and adaptable to different applications.

The control module 86 includes the electronic and logic circuits to monitor and control the desalination system, communicate with a topside control room and execute commands.

FIG. 11 largely corresponds to FIG. 10 with three desalination templates 20 instead of twelve, and also including some more details. Chemicals for cleaning can be supplied through the chemical line 53 extending from a chemical reservoir on land or on the service vessel. In some cases, local chemical supply could be an advantage or necessary. In these cases, a chemical injection module 48 contains one or several chemical containers and required pumps, piping/ducting, instrumentations and control systems for cleaning, maintenance and disinfection purposes. Chemicals are injected into, and mixed with the desalinated water flow for cleaning, maintenance and disinfection purposes. Different types of chemicals are used in “clean-in-place solution” to backflush desalination RO-modules with RO-cartridges or pre-filter assemblies. The chemical injection modules 48 are retrievable, interchangeable and replaceable.

The control functions may be integrated in at least one module to omit a separate control module.

FIG. 11 shows three desalination templates 20 each including a desalinated water line coupling 28 connecting the desalinated water pipeline 43, a power line coupling 62 connecting a power line 52, a chemical line coupling 49 connecting a chemical line 53, and a concentrated seawater outlet 44 with a discharge line. In FIG. 11 however there is a separate retrievable transport module 6 and a separate retrievable seawater booster module 2. The chemical injection module 48 is provided for cleaning the desalination system. The six open squares represent desalination RO-modules 4. A control system may include sensors monitoring pressures, volumetric flows, salinity, power consumption, temperatures etc.

The transport module 6 includes a submergible electric motor and a pump connected by a drive shaft/coupling. The pump provides the necessary head in the desalinated water. Power to the electric motor may be provided by electric jumpers from a power cable termination (not shown) instead of the stab in connections. Such jumpers can be connected and disconnected by an ROV. The pump is connected to the template piping/ducting with a fluid inlet and a fluid outlet. The transport module 6 contain ancillary systems and devices to ensure reliable operation of the pump and motor, e.g. motor cooling system, lubrication system, valves and instrumentation for monitoring and control. The pump module is located downstream of the desalination RO-modules 4.

The booster module 2 for seawater is placed up-stream of the desalination modules.

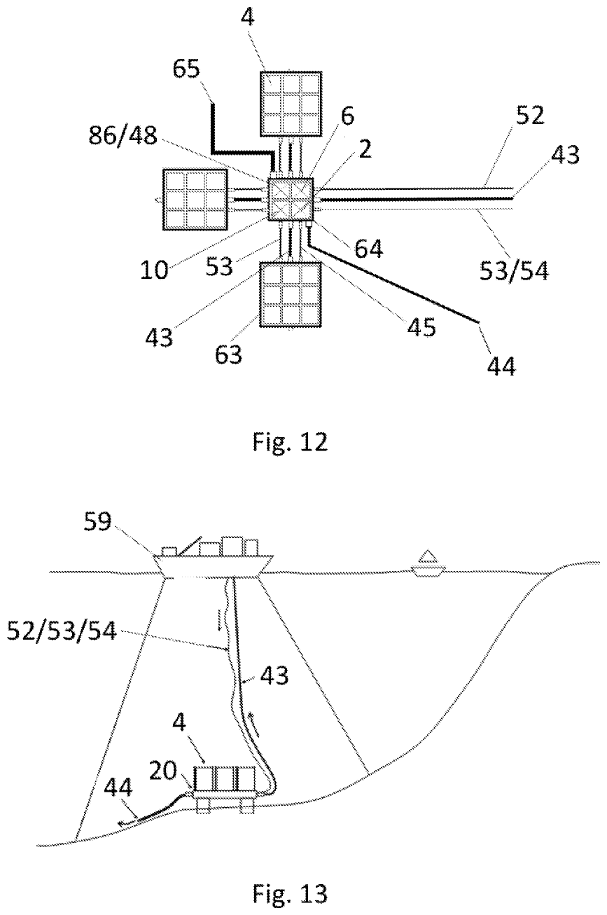

FIG. 12 shows an alternative configuration of a desalination system of the invention with a separate pump template 64 serving several desalination templates 63. The desalination templates 63 are without pumps or control modules. The pump template 64 includes a retrievable chemical injection module 48, a retrievable desalinated water transport module 6, a retrievable seawater booster module 2, a retrievable energy recovery module 10 and a retrievable control module 86. The retrievable seawater booster module 2 and the transport module 6 are shown in separate retrievable modules but could have been located in the same module. The desalination templates 63 only include desalination RO-modules 4. Concentrated seawater outlet 44 with discharge tubulars lead concentrated seawater away from the pump template 64. The line for electric power 52, the control cable 54 and the connection line with the desalinated water pipeline 43 runs to the desalinated water receiving facility on a floating vessel or a topside facility. The pump template 64 provides a flow path between the seawater entrance 65 and the seawater booster module 2. The inlet tubular 45 provides the flow path for seawater from the separate pump template 64 and to the desalination templates 63. Seawater is pumped from the seawater inlet 65, through the pump template 64, through the seawater booster pump 2, through the pump template 64, through the inlet tubular 45, through the desalination template 63, through the desalination RO-module 4, past and partly through the RO-cartridges to be separated into concentrated seawater and desalinated water, whereby the concentrated seawater flows through the template and out of the concentrated seawater outlet 44. The desalinated water flows into the desalination template 63, through the pump template 64, through the transport module 6, through the pump template 64, through the desalinated water pipeline 43 and to the desalinated water receiving facility (not shown in FIG. 12).

The chemical injection module 48 includes a tank or several tanks with chemicals to be injected into the desalination RO-modules 4, in particular on the seawater side of the cartridges to remove fouling, scaling etc. that reduces or prevents flow of water through the cartridges. Chemicals such as citric acid can also be injected into the desalinated side of the cartridges to flush the cartridges in a reversed flow direction.

In FIG. 12, the separate pump template 64 serve three desalination templates 63 without pumps or control modules, but a higher or lower number of desalination templates may clearly be served.

FIG. 13 shows the desalination system of the invention in an alternative embodiment with a floating desalinated water receiving facility 20. Desalinated water is pumped to the floating desalinated water receiving facility 59 through the desalinated water pipeline 43. Chemical line 53, power cable 52 and control cable 54 convey the required consumables to the desalination template 20 with the desalination RO-modules 4. The concentrated seawater outlet 44 with the discharge tubular leads the concentrated seawater a distance away from the desalination template 20 and to a location where the concentrated seawater not will have a negative influence on the local marine life.

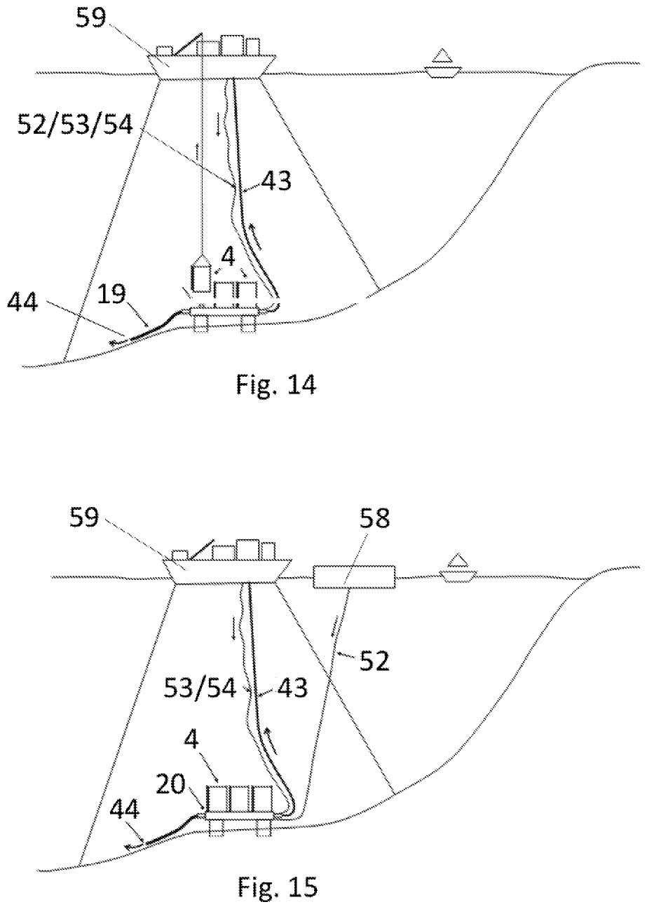

FIG. 14 shows the embodiment of FIG. 13 and highlights that a floating desalinated water receiving facility 59 also can be used to exchange the modules such as the desalination RO-modules 4 for service and maintenance. Cleaning chemicals are conveyed through the chemical line 53. The concentrated seawater is led through the concentrated seawater line 19 out of the concentrated seawater outlet 44 away from the template with the discharge tubular.

FIG. 15 shows the embodiment of FIGS. 13 and 14, apart from also showing a separate floating power generation unit 58. The power generation unit 58 can include systems providing renewable energy from waves, the wind, the sun, tidal currents etc. Alternatively, the power generation unit 58 can include a combustion engine and a generator. The power line extends from the floating power generation unit 58 and to the desalination system on the template 20 at the seabed.

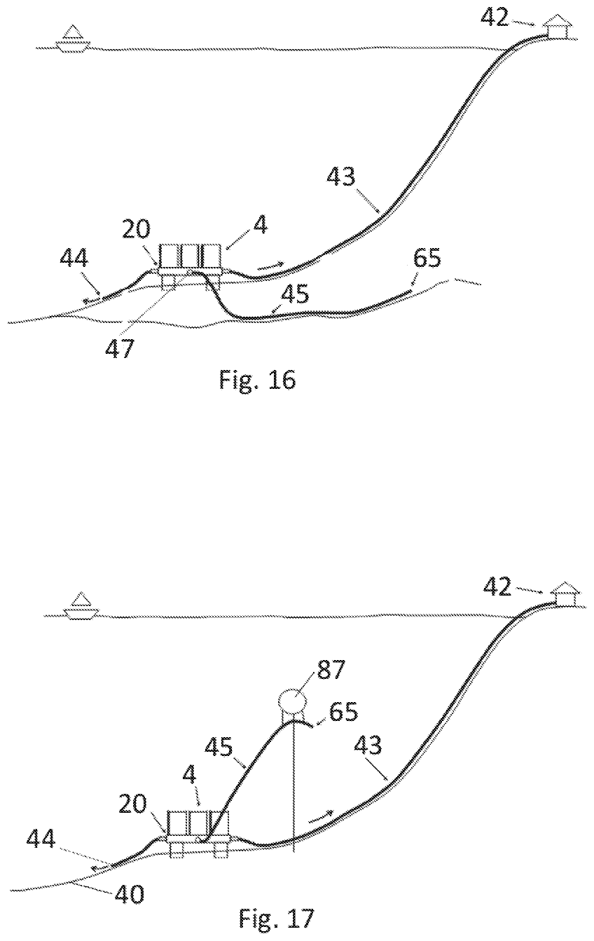

FIG. 16 shows an alternative embodiment of the invention with the seawater inlet of the desalination template 20 connected to an inlet tubular 45 with a seawater entrance 65 at a remote location relative to the subsea desalination template 20. The inlet tubular 45 connected to the seawater inlet 47 on the subsea desalination template 20 may be used to provide seawater with a more favourable quality to the desalination RO-modules 4, including lower concentration of pollution, biological material, salt, or other unwanted substances. The concentrated seawater outlet 44 is located away from the seawater entrance 65 to prevent concentrated seawater from entering the seawater entrance 65. The shore based desalinated water receiving facility 42 connected to the desalination template 20 through the desalinated water pipeline 43 requires a small footprint comparted to a complete desalination plant.

FIG. 17 shows an alternative embodiment corresponding to the embodiment of FIG. 16, but where the inlet tubular 45 with a seawater entrance 65 is elevated from the seabed 40 and the inlet tubular 45 is secured to a floating buoy 87 moored to the seabed 40.

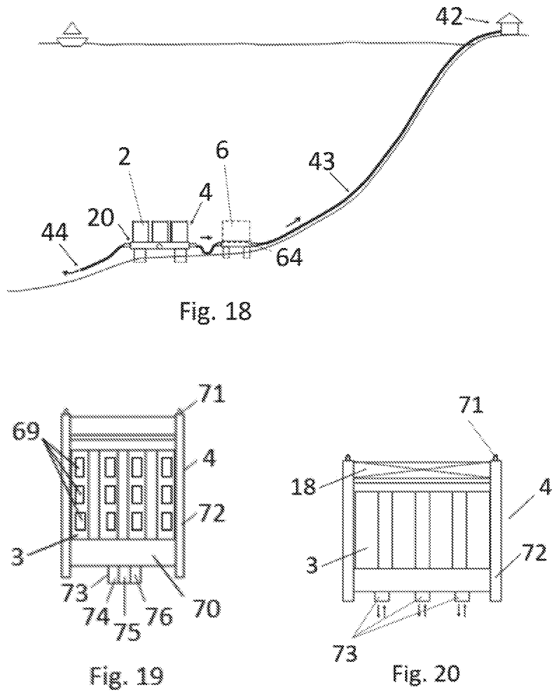

FIG. 18 shows an alternative embodiment where the transport module 6 is located on a pump template 64 downstream of the desalination template 20. The desalinated water is pumped through the desalinated water line 43 to the receiving facility 42.

FIG. 19 shows an embodiment of the desalination RO-module 4 of the invention with a seawater intake 74 in the subsea template fluid coupling 73 to allow seawater from the booster pump to be pumped into the desalination RO-module. A desalinated water outlet 75 and a concentrated seawater outlet 76 are also included in the subsea template fluid coupling 73. The template fluid coupling 73 is located at the bottom side 70 of the module and are adapted for connection with the template. The desalination RO-module 4 contains a plurality of RO cartridges 69 in the RO cartridge assembly 3. The desalination RO-module 4 has lifting connectors 71 mounted on the outer module frame 72.

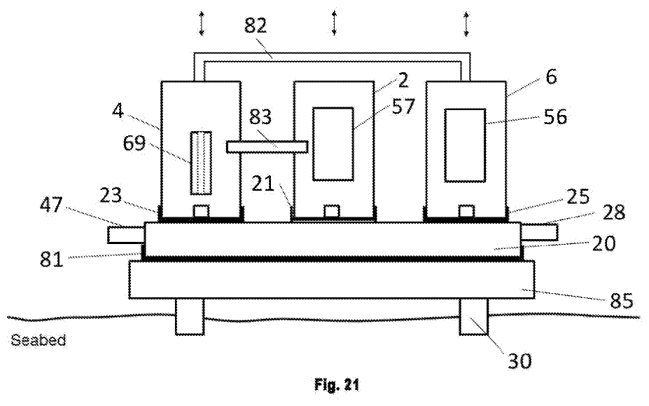

FIG. 20 shows an alternative embodiment of the desalination RO-module 4 with three separate template couplings 73 at the bottom side 70 of the module. The template couplings 73 are adapted to be connected to the module couplings of the module zones of the templates. The pump modules may have similar couplings. The seawater filter 18 is connected upstream of the RO-cartridge assembly 3 in the desalination RO-module 4.

FIG. 21 shows an alternative embodiment where the desalination template 20 is retrievable and is located on a permanent seabed foundation 85 secured to seabed anchoring elements 30. The permanent seabed foundation 85 does not include any piping or other features requiring maintenance and service. A template holding frame 81 on the permanent seabed foundation 85 localizes the desalination template 20 on the permanent seabed foundation 85. The retrievable desalination template 20 is allowed be retrieved for service and repair while the permanent seabed foundation 85 ensures that the desalination template 20 maintains its position after deployment.

Jumpers 82 and 83 connect the desalination RO-module 4 in the desalination RO-module zone 23, the booster module 2 with the booster pump assembly 57 in the booster module zone 21 and the transport module 6 with transport pump assembly 56 in the transport module zone 25 to indicate that not all the connections need to be made up within the desalination template 20.

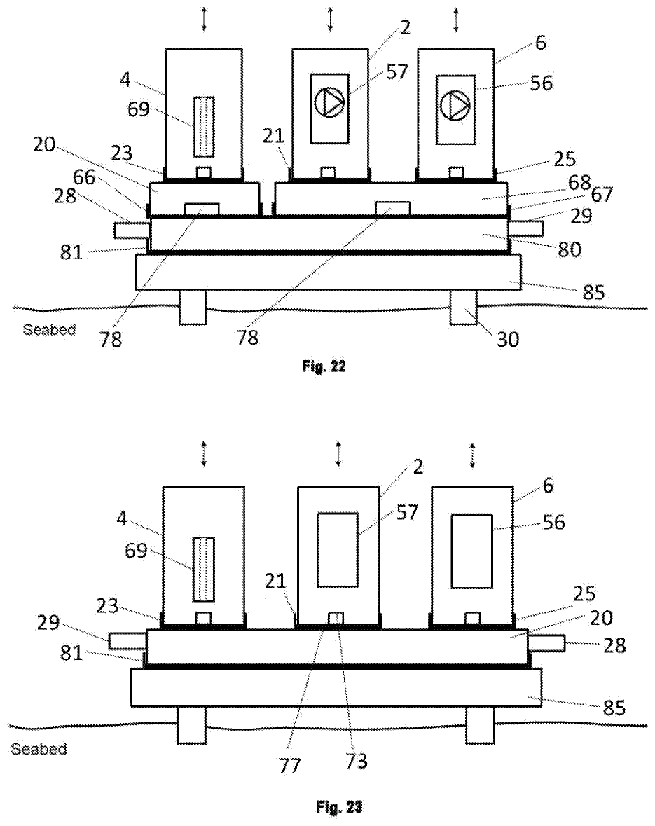

FIG. 22 shows yet another embodiment where the desalination template 20 with a desalination RO-module zone 23 is retrievable and is located on top of a separate base template 80 with a desalination template zone 66. The base template 80 includes piping (not shown), is retrievable and is located on the permanent seabed foundation 85 secured to seabed anchoring elements 30. A template connection 78 forms an interface and connection between the desalination template 20 and the base template 80. The desalinated water outlet coupling 28 and the concentrated seawater outlet coupling 29 are located on the base template 80 and piping in/on the base template 80 connects the base template and the desalination template 20. A desalination template holding frame 66 on the base template 80 localizes the desalination template 20 on the base template 80.

Similarly, a pump template 68 with the booster module 2 and the transport module 6 installed in their respective pump module zones 21 and 25 is installed on the base template 80 with a pump template zone 67. A template connection 78 forms an interface and connection between pump template 68 and the base template 80.

A template holding frame 81 on the permanent seabed foundation 85 localizes the base template 80 on the permanent seabed foundation 85.

FIG. 23 is a schematic representation of the subsea desalination system with a desalination template 20 located on a permanent seabed foundation 85. All the fluid connections between the desalination template 20 and the modules 4, 6, 2 go through subsea template fluid couplings 73 and module fluid couplings 77. Additional couplings for power and control also go through the template and to the modules. The template holding frame 81 on the permanent seabed foundation 85 holds the template 20 in place.

A discharge unit (not shown) may include bespoke discharge modules located on a template to facilitate a controlled and well distributed water discharge. The discharge unit is connected to the desalinated water template. The discharge modules are retrievable and replaceable.

The desalination system described above with reference to the enclosed figures is remotely monitored, controlled and operated from an onshore control centre or from an offshore surface vessel. The control centre may be anywhere and may be connected to the onshore control centre of the desalination system e.g. via internet. The control centre is connected to the subsea system via an offshore data and instrument cable. All pumps, electrical equipment and instrumentation are typically monitored and controlled via the data and instrumentation cable, or via satellites and a floating buoy. Communication between the floating buoy and satellite could be via e.g. an antenna/sending receiving unit on the sea surface connected to the subsea equipment.

The electrical equipment and the instrumentation may be monitored and controlled from a vessel operating the desalination system.

The service vessel may commute between an onshore supply base and the location of the subsea desalination system. The onshore storage supply base may be located near the subsea desalination system where there are spare desalination RO-modules and pump modules ready for shipping. Desalination RO-modules are replaced on a regular basis or every time there is an issue with a certain module. The service vessel can carry one or several new/serviced desalination RO-modules from the onshore supply base to the location of the subsea desalination system and lower the one or several desalination RO-modules onto the desalination template. The new/serviced desalination RO-module is then installed on the subsea template replacing the retrieved desalination RO-module. This operation may continue until all selected subsea modules are replaced with replacement desalination RO-modules. Replacement of the pump, control and chemical modules is executed the same way. The subsea pump, chemical and control modules are lifted onboard the supply vessel before a replacement pump, chemical or control module is lowered and installed on the subsea template replacing the retrieved pump or control module. All the retrieved modules are taken to the supply base onshore for servicing.

The above embodiments of the invention are described with specific modules and locations. It is however intended that the various solutions can be combined in a system of the invention. For instance, the solution with a line conveying chemicals from the water receiving facility or the solution with a module containing one or several tanks containing chemicals at the seabed can be combined with any of the embodiments. Similarly, may all the embodiments include a booster pump in a dedicated module, or in a combined pumping module with both a booster pump and a transport pump. All the embodiments can be utilized as a floating desalinated water receiving facility or as a receiving facility on land, all the embodiments can utilize a remote seawater entrance etc. Similarly, can the various templates with module zones or template zones be provided in any combination.

In the above description a template intended to cover a frame located on a seabed or on a foundation on a seabed. The frame includes piping and connections to connect the template to retrievable modules. The term retrievable is intended to cover adapted to be launched or retrieved from a vessel and adapted to be exchangeable and thus include connections and attachments providing simple exchange with an ROV preferably without using divers or other interventions.

1. A shallow water desalination system comprising:
a subsea desalination template adapted to be located on a seabed, including at least one Reverse Osmosis (RO)-module zone, at least one RO-module connection and desalination template piping in fluid connection with the at least one RO-module connection;
at least one retrievable subsea RO-module adapted to be placed in the at least one RO-module zone of the subsea desalination template, the at least one retrievable subsea RO-module including a RO-template connection adapted to be connected to the at least one RO-module connection, and at least one RO-cartridge assembly (3) in fluid connection with the RO-template connection;
at least one seawater booster pump assembly with an inlet and an outlet adapted to be in fluid connection with a seawater inlet side of the at least one RO-cartridge assembly;
at least one retrievable subsea booster module including at the at least one seawater booster pump assembly;
at least one booster module template connection on the at least one retrievable subsea booster module, adapted to be connected to a booster module connection on a template with a booster module zone;
at least one desalinated water line adapted to convey desalinated water from the at least one retrievable subsea RO-module to a location above a sea level; and
a pressure regulator in fluid connection with a retentate side of the least one retrievable subsea RO-module.

2. The shallow water desalination system of claim 1, wherein the template with a booster module zone is the desalination template.

3. The shallow water subsea desalination system of claim 1, further including at least one desalinated water transport pump assembly in fluid connection with a desalinated water side of the at least one RO-cartridge assembly in the retrievable subsea RO-module.

4. The shallow water desalination system of claim 3, wherein the at least one seawater booster pump assembly and the at least one desalinated water transport pump assembly are located in the booster module.

5. The shallow water desalination system of claim 3, wherein the at least one desalinated water transport pump assembly is located in a retrievable subsea desalinated water transport module, and wherein the retrievable transport module is adapted to be located in a desalinated water transport module zone.

6. The shallow water desalination system of claim 1 wherein the pressure regulator includes an energy recovery assembly.

7. The shallow water desalination system of claim 6, wherein the energy recovery assembly is located in a separate retrievable energy recovery module.

8. The shallow water desalination system of claim 6 wherein the energy recovery assembly includes a turbine aggregate with a turbine and one of an electric generator and a mechanical connection through a transmission to the booster pump or the transport pump.

9. The shallow water desalination system of claim 1, further including at least one retrievable control module located in at least one control module zone on the desalination template.

10. The shallow water desalination system of claim 1, further including a prefilter assembly in a retrievable prefilter module upstream of the booster pump assembly.

11. The shallow water desalination system of claim 10, wherein the retrievable prefilter module includes a filter and is located on a separate filtering and pumping station, and wherein the booster module is located on the filtering and pumping station upstream and in fluid connection with the desalination template.

12. The shallow water desalination system of claim 5, wherein at least one separate pump template with the at least one transport module is located on a downstream side of the at least one subsea desalination template and includes a desalinated water inlet and a desalinated water outlet, whereby the separate pump template with the at least one transport module is adapted to convey the desalinated water from the desalination template.

13. The shallow water desalination system of claim 5, wherein at least one separate pump template with the at least one transport module is located on a downstream side of the at least one subsea desalination template and includes a desalinated water inlet and a desalinated water outlet, whereby the separate pump template with the at least one transport module is adapted to convey the desalinated water from the desalination template.

14. The shallow water desalination system of claim 1, further including a permanent seabed foundation secured to seabed anchoring elements, and wherein any of the subsea templates are adapted to be located on top of the permanent seabed foundation.

15. The shallow water desalination system of claim 1, wherein any of the subsea templates are adapted to be located on a further base template in fluid connection with the desalinated water pipeline and a concentrated seawater outlet.

16. The shallow water desalination system of claim 15, wherein the further subsea base template is adapted to be located on top of a permanent seabed foundation.

17. A subsea desalination booster module for a desalination system, comprising:
at least one seawater booster pump assembly with an inlet and an outlet adapted to be in fluid connection with a seawater inlet side of at least one RO-cartridge assembly; and
at least one booster module template connection on the at least one retrievable subsea booster module, adapted to be connected to a booster module connection on a template with a booster module zone.
